(19) United States
(12) Patent Application Publication
(10) Pub. No.: US 2018/0100811 A1
(43) Pub. Date: Apr. 12, 2018

(54) FERRULE ENDFACE INSPECTING DEVICE AND METHOD FOR OPTICAL COMMUNICATION MODULES

(71) Applicant: Electronics and Telecommunications Research Institute, Daejeon (KR)

(72) Inventors: Hong Yeon YU, Gwangju (KR); Kwon Seob Lim, Gwangju (KR); Dae Seon Kim, Daejeon (KR)

(73) Assignee: Electronics and Telecommunications Research Institute, Daejeon (KR)

(21) Appl. No.: 15/496,164

(22) Filed: Apr. 25, 2017

(30) Foreign Application Priority Data
Oct. 7, 2016 (KR) 10-2016-0129668

(51) Int. Cl. G01N 21/94; G02B 6/38; H04N 7/18; G06K 9/46; G06T 7/11

(52) U.S. Cl. CPC G01N 21/94; G02B 6/3898; G02B 6/3866; H04B 10/07; G06K 9/4604; G06T 7/11; G06T 2207/30204; H04N 7/181

(57) ABSTRACT

Provided is a ferrule endface inspecting device for optical communication modules. The ferrule endface inspecting device includes an XY movement stage, a mount head moving in a two-axis direction including an X-axis direction and a Y-axis direction by the XY movement stage and rotating on an X-Y plane, a jig unit disposed under the mount head to fix optical communication modules with a built-in ferrule, and a control unit selecting a ferrule region located at an inspection start position from among a plurality of ferrule regions extracted from a whole image of the jig unit captured by a first camera and analyzing a ferrule endface image obtained through photographing by a second camera, which has rotated and moved to the inspection start position, to determine whether there is a defect of a ferrule endface. The first and second cameras are provided on a side of the mount head.

### CROSS-REFERENCE TO RELATED APPLICATIONS

This application claims priority under 35 U.S.C. § 119 to Korean Patent Application No. 10-2016-0129668, filed on Oct. 7, 2016, the disclosure of which is incorporated herein by reference in its entirety.

### TECHNICAL FIELD

The present invention relates to a device and a method, which automatically inspect a ferrule endface for an optical communication module through image processing.

### BACKGROUND

Generally, optical communication modules applied to an optical communication system include a submodule, including receptacle parts each including an optical ferrule, such as TOSA, ROSA, TO-CAN, etc., or an optical transceiver module including the submodule. The receptacle parts manufactured as a module type is manufactured as a female type where a ferrule endface is disposed in a certain depth, and the manufactured receptacle parts are coupled to various parts.

In the receptacle parts, pollutants such as particles and oil can be adsorbed onto an endface of a ferrule in a manufacturing process or a product transport process. The pollutants decrease an optical signal transmission performance of products, causing the reduction in reliability of the products.

Therefore, a process of removing the pollutants adsorbed onto the endface of the ferrule is needed in the manufacturing process or after a product is transported, and an automation total inspection system based on a quantitative criterion is necessary for enabling a number of modules to be produced at the proper time.

A related art automation total inspection system is a system for inspecting a male type optical connector (for example, FC, SC, ST, LC, MU, SMA, etc.) including a ferrule endface which protrudes to the outside. In the related art automation total inspection system, an inspection target is mounted on a jig suitable for each type, and an image of a ferrule endface is obtained through various optical systems and movable stages. Also, the related art automation total inspection system analyzes the obtained image of the ferrule endface by using image processing technology to determine a polluted state of the ferrule endface.

In optical communication modules (or submodules) such as TOSA, ROSA, TO-CAN, and transceiver coupled to a receptacle part, a ferrule does not protrude to the outside, and a ferrule endface including an optical fiber is disposed in a certain depth in a housing of the receptacle part. Also, a position of the ferrule endface in the housing is set in various depths depending on a type of an optical communication module or a submodule.

Therefore, the related art automation total inspection system is a device for inspecting male type optical connectors each including a ferrule endface which protrudes to the outside, and has a problem where it is unable to inspect ferrule endfaces of various female type optical communication modules or submodules. Particularly, since determining the number (the number of ferrule endfaces or parts) and types of inspection targets from a jig with the inspection target mounted thereon is needed for automatically inspecting various types of optical communication modules or submodules, it is difficult to establish an automation total inspection system, and it is unable to accurately remove pollutants adsorbed onto a ferrule endface.

### SUMMARY

Accordingly, the present invention provides a ferrule endface inspecting device and method for optical communication modules, which accurately determine a position of a ferrule endface in various types of optical communication modules or submodules (or parts) each including the ferrule endface having the position set in a certain depth and automatically inspect a polluted state of the ferrule endface disposed at the determined position, in a process of manufacturing the various types of optical communication modules (or submodules, parts, etc.).

In one general aspect, a ferrule endface inspecting device for optical communication modules includes: an XY movement stage; a mount head moving in a two-axis direction including an X-axis direction and a Y-axis direction by the XY movement stage and rotating on an X-Y plane, first and second cameras being provided on a side of the mount head; a jig unit disposed under the mount head to fix a plurality of optical communication modules with a built-in ferrule; and a control unit selecting a ferrule region located at an inspection start position from among a plurality of ferrule regions extracted from a whole image of the jig unit captured by the first camera and analyzing a ferrule endface image obtained through photographing by the second camera, which has rotated and moved to the inspection start position, to determine whether there is a defect of a ferrule endface.

In another general aspect, a ferrule endface inspecting method for optical communication modules includes: transporting, by a jig transport robot, a jig unit to a jig fixing part, the jig unit fixing a plurality of optical communication modules with a built-in ferrule; moving, by an XY movement stage, a mount head to on the jig unit, the mount head being movable in an X-axis direction and a Y-axis direction; obtaining, by a first camera provided in the mount head, a whole image of the jig unit by photographing a whole region of the jig unit; extracting, by a control unit, a plurality of ferrule regions from the whole image of the jig unit to select a ferrule region located at an inspection start position from among the extracted plurality of ferrule regions; rotating and moving, by a second camera, to the inspection start position by the mount head to photograph the selected ferrule region; and analyzing, by the control unit, a ferrule endface image obtained by photographing the selected ferrule region to determine whether there is a defect of a ferrule endface.

Other features and aspects will be apparent from the following detailed description, the drawings, and the claims.

### BRIEF DESCRIPTION OF THE DRAWINGS

FIG. 1 is a block diagram illustrating a ferrule endface inspecting device for optical communication modules (or submodules, parts, etc.) according to an embodiment of the present invention.

FIG. 2 is a front view of inspection equipment illustrated in FIG. 1.

FIG. 3 is a side view of the inspection equipment illustrated in FIG. 1.

FIG. 4 is a plan view of a jig unit illustrated in FIG. 1.

FIG. 5 is a block diagram of control equipment illustrated in FIG. 1.

FIG. 6 is a flowchart illustrating an inspection target candidate region extracting operation of a first image processing unit according to an embodiment of the present invention.

FIG. 7 is a flowchart illustrating a pollutants detecting method of a second image processing unit according to an embodiment of the present invention.

FIG. 8 is a flowchart illustrating a ferrule endface inspecting method according to an embodiment of the present invention.

### DETAILED DESCRIPTION OF EMBODIMENTS

Hereinafter, example embodiments of the present invention will be described in detail with reference to the accompanying drawings. Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In various embodiments of the disclosure, the meaning of ‘comprise’, ‘include’, or ‘have’ specifies a property, a region, a fixed number, a step, a process, an element and/or a component but does not exclude other properties, regions, fixed numbers, steps, processes, elements and/or components.

As used herein, the term “or” includes any and all combinations of one or more of the associated listed items. For example, “A or B” may include A, include B, or include A and B.

In the following description, the technical terms are used only for explain a specific embodiment while not limiting the present invention. The terms of a singular form may include plural forms unless referred to the contrary.

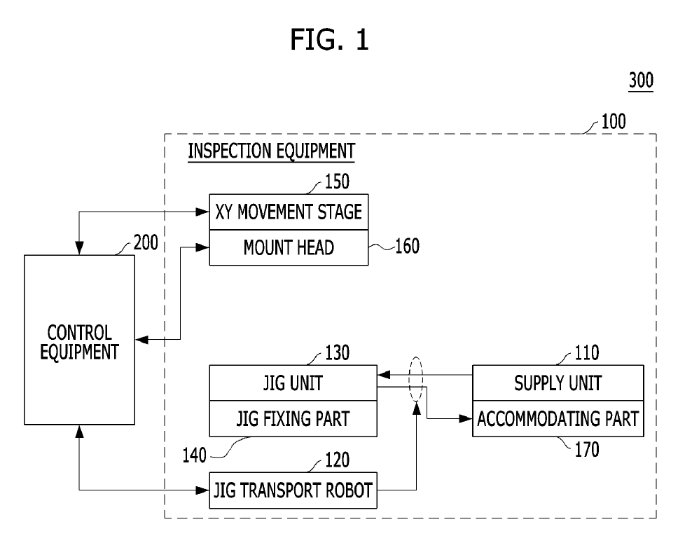

FIG. 1 is a block diagram illustrating a ferrule endface inspecting device 300 for optical communication modules (or submodules, parts, etc.) according to an embodiment of the present invention.

Referring to FIG. 1, the ferrule endface inspecting device 300 for optical communication modules (or submodules, parts, etc.) according to an embodiment of the present invention may be a device for inspecting a defect of a ferrule endface and may include ferrule inspection equipment 100 and control equipment 200.

The inspection equipment 100 may include a supply unit 110, a jig transport robot 120, a jig unit 130, a jig fixing part 140, an XY movement stage 150, a mount head 160, and an accommodating part 170.

The supply unit 110 may supply the jig unit 130 which is to be inspected.

The jig transport robot 120 may transport the jig unit 130 accommodated into the supply unit 110 to the jig fixing part 140 and may transport the jig unit 130, for which inspection has been completed, to the accommodating part 170 according to control by the control equipment 200, whereupon the jig unit 130 may be accommodated into the accommodating part 170.

The jig unit 130 may include a jig which fixes a plurality of optical communication modules, which are to be inspected, to be arranged in an array form. Here, each of the optical communication modules which are to be inspected may be one of a receptacle part manufactured as a female type where a ferrule does not protrude to the outside, a submodule including the receptacle part, and an optical transceiver module including the submodule. Examples of the receptacle part into which the ferrule is embedded as a female type may include receptacle parts having types such as TOSA, ROSA, and TO-CAN types. Therefore, the jig may include a plurality of insertion grooves having different shapes and sizes for fixing various kinds of optical communication modules.

The jig fixing part 140 may be an element for providing an inspection position of the jig unit 130 and may fix the jig unit 130 so as not to move in an inspection process.

The XY movement stage 150 may move the mount head 160 in a two-axis direction including an X-axis direction and a Y-axis direction over the jig unit 130 according to control by the control equipment 200.

The mount head 160 may move and rotate in the two-axis direction and an up and down direction (a Z-axis direction) over the jig unit 130 according to control by the control equipment 200 so as to photograph a front surface of the jig unit 130 and a ferrule endface included in each of the optical communication modules arranged in the jig unit 130.

The control equipment 200 may detect a plurality of ferrule regions from a front image supplied from the mount head 160, select a ferrule region corresponding to a first inspection target from among the detected plurality of ferrule regions, and control the mount head 160 to remove pollutants from a ferrule endface of the selected ferrule region.

Moreover, the control equipment 200 may analyze an image of the ferrule endface supplied from the mount head 160 to detect a core region, a cladding region, and a buffer region of the ferrule, and may analyze an intensity value distribution of each of the detected regions to determine the presence of a defect.

Moreover, the control equipment 200 may provide a result of the defect determination to an inspector as a report having a visualized map form.

When inspection of a defect has been completed on all ferrule endfaces included in the jig unit 130, the jig transport robot 120 may transport an inspection-completed jig unit 130 to the accommodating part 170 according to control by the control equipment 200, and the transported jig unit 130 may be accommodated into the accommodating part 170.

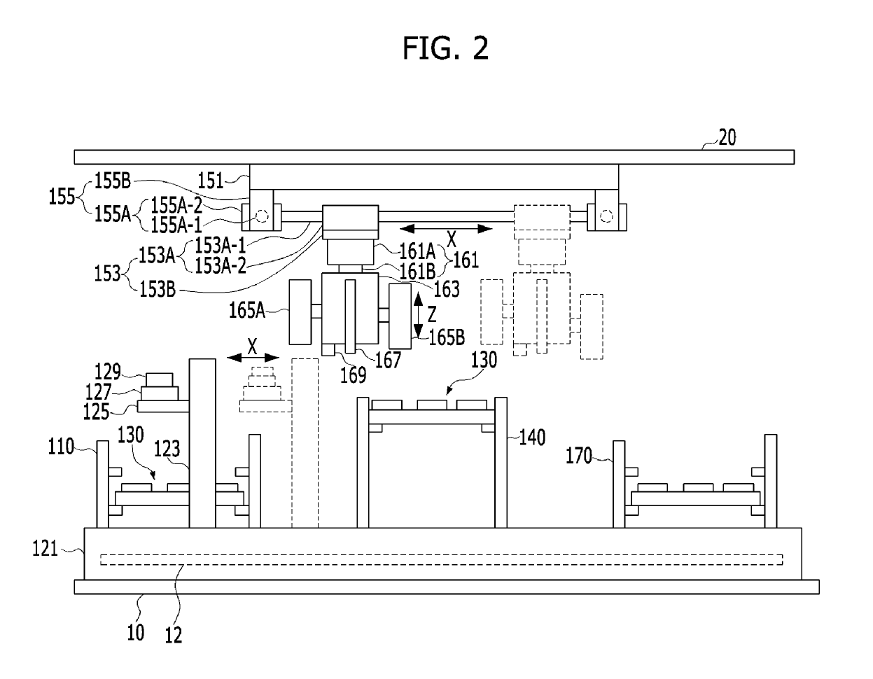

Hereinafter, main elements of the inspection equipment illustrated in FIG. 1 will be described in more detail with reference to FIGS. 2 to 4.

Jig Transport Robot 120

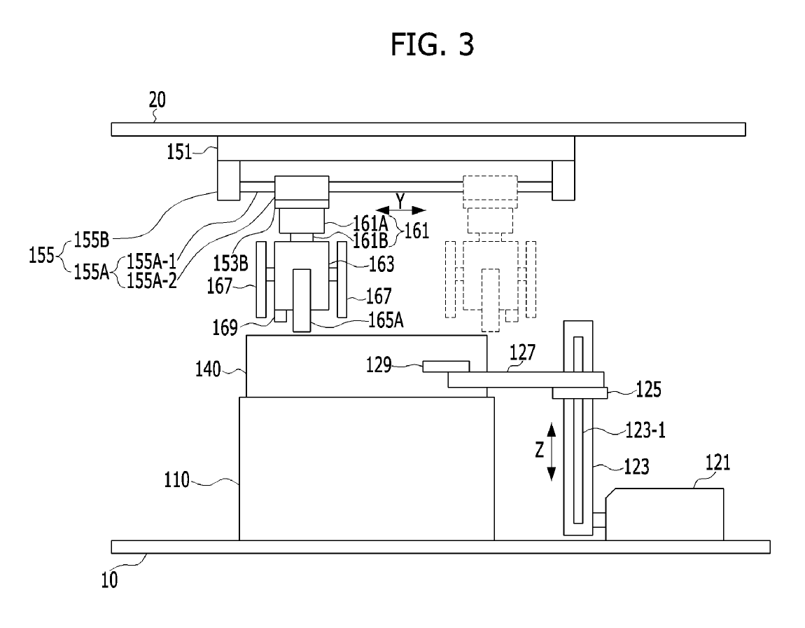

Referring to FIGS. 2 and 3, the jig transport robot 120 may be installed on a lower frame 10. The jig transport robot 120 may unload the jig unit 130 from the supply unit 110 installed on the lower frame 10, transport the unloaded jig unit 130 to the jig fixing part 130, and transport the jig unit 130, for which inspection has been completed, to the accommodating part 170, whereupon the transported jig unit 130 may be accommodated into the accommodating part 170.

To this end, the jig transport robot 120 may include a base 121 including a rail 12 disposed on a side thereof, an X-axis movement body 123 vertically coupled to the rail 12 disposed on the side of the base 121 to rectilinearly shuttle in the X-axis direction, a sliding member 125 coupled to the X-axis movement body 123 to be movable in the up and down direction (the Z-axis direction), an arm 127 including one end rotatably coupled to the sliding member 125, and a hand 129 rotatably coupled to the other end of the arm 127.

The rail 12 disposed on the side of the base 121 may be provided in the X-axis direction and may allow the movement body 123 to rectilinearly shuttle on the rail 12 and to transport the jig unit 130 in the X-axis direction.

The sliding member 125 coupled to the X-axis movement body 123 may rectilinearly shuttle in the X-axis direction on the rail 12 provided in the base 10 to transport the jig unit 130 in the X-axis direction.

Likewise with the base 121, a rail 123-1 may be provided in the X-axis movement body 123. The rail 123-1 provided in the movement body 123 may be provided in the Z-axis direction and may allow the sliding member 125 to upward and downward move in the Z-axis direction.

When the sliding member 125 vertically moves in the Z-axis direction on the rail 123-1 provided in the X-axis movement body 123, the arm 127 coupled to the sliding member 125 may vertically move in the Z-axis direction along with the hand 129 coupled to the arm 127. Therefore, the jig unit 130 fixed and supported to the hand 129 may vertically move.

Although not shown, a motor which allows the one end of the arm 127 to rotate on the sliding member 125 may be disposed at an appropriate position, and another motor which allows the hand 129 to rotate on the other end of the arm 127 may be disposed at an appropriate position. The hand 129 may freely move in the Y-axis direction according to the arm 127 and the hand being respectively rotated by the motors. Operations of the motors may be controlled by the control equipment 200.

Although schematically shown in the drawing, the hand 129 may have various types which enable the hand 129 to move to the inside of the supply unit 110 and to grip a specific position of the jig unit 130 accommodated into the supply unit 110.

XY Movement Stage 150

Referring to FIGS. 2 and 3, the XY movement stage 150 may include a surface plate 151, an X-axis movement body 153, and a Y-axis movement body 155.

The surface plate 151 may be disposed on an upper frame 20 and may have a rectangular parallelepiped shape. A surface of the surface plate 151 may be configured to have a high plane level through plane processing.

The X-axis movement body 153 may include an X-axis shaft motor 153A and a mount head positioning part 153B fixed and coupled to the X-axis shaft motor 153A, and the mount head positioning part 153B may move in the X-axis direction on the surface plate 151 according to the X-axis shaft motor 153A being driven.

The X-axis shaft motor 153A may include an X-axis shaft 153A-1 functioning as a stator and an X-axis coil 153A-2 functioning as an actuator.

The X-axis shaft 153A-1 may include a magnetic substance that internally generates a magnetic force. The X-axis shaft 153A-1 may extend in the X-axis direction, and both ends of the X-axis shaft 153A-1 may be fixed and coupled to the Y-axis movement body 155.

The X-axis coil 153A-2 may be inserted into and coupled to an outer side of the X-axis shaft 153A-1 and may move in the X-axis direction in which the X-axis shaft 153A-1 extends, whereby the mount head positioning part 153B may be fixed and coupled to the X-axis coil 153A-2.

When a current is applied to the X-axis coil 153A-2, the X-axis coil 153A-2 may be moved in the X-axis direction by an electromagnetic force generated between the X-axis coil 153A-2 and the X-axis shaft 153A-1. Therefore, the mount head positioning part 153B fixed and coupled to the X-axis coil 153A-2 may move in the X-axis direction.

The Y-axis movement body 155 may be disposed over the surface plate 151 and may be spaced apart from the surface plate 151 in the X-axis direction. The Y-axis movement body 155 may be an element, which moves the X-axis movement body 153 over the surface plate 151, and may include a Y-axis shaft motor 155A and a fixing part 155B.

The Y-axis shaft motor 155A may include a Y-axis shaft 155A-1 functioning as a stator and a Y-axis coil 155A-2 functioning as an actuator.

The Y-axis shaft 155A-1 may include a magnetic substance that internally generates a magnetic force. The Y-axis shaft 155A-1 may extend in the Y-axis direction and may be fixed and coupled to the fixing part 155B provided in each of four corners of the surface plate 151.

The Y-axis coil 155A-2 may be inserted into and coupled to an outer side of the Y-axis shaft 155A-1 and may move in the Y-axis direction in which the Y-axis shaft 155A-1 extends. At this time, both ends of the X-axis shaft 153A may be fixed and coupled to the Y-axis coil 155A-2 spaced apart therefrom in the X-axis direction.

When a current is applied to the Y-axis coil 155A-2, the Y-axis coil 155A-2 may be moved in the Y-axis direction by an electromagnetic force generated between the Y-axis coil 155A-2 and the Y-axis shaft 155A-1. Therefore, the X-axis shaft 153A-1 may move in the Y-axis direction according to movement of the Y-axis coil 155A-1, and thus, the X-axis movement body 153 may move in the Y-axis direction.

Mount Head 160

Referring to FIGS. 2 and 3, the mount head 160 may be coupled to the mount head positioning part 153B and may photograph the jig unit 130 while moving in the X-axis direction and the Y-axis direction over the jig unit 130. The mount head 160 may include a rotation driver 161, a body part 163, a first camera 165A, a second camera 165B, a pollutant remover 167, and a lighting unit 169.

The rotation driver 161 may be an element that rotates the body part 163, and may include a rotation motor 161A and a rotation shaft 161B.

The rotation motor 161A may be coupled to the mount head positioning part 153B and may generate a rotation force. The rotation shaft 161B may transfer the rotation force, generated by the rotation motor 161A, to the body part 163.

The body part 163 may be fixed and coupled to the rotation shaft 161B and may enable the rotation shaft 161b to rotate. The first camera 165A, the second camera 165B, and the pollutant remover 167 may be disposed on a side of the body part 163. For example, the first camera 165A, the second camera 165B, and the pollutant remover 167 may be arranged at 90-degree intervals on the side.

The first camera 165A, the second camera 165B, and the pollutant remover 167 disposed on the side of the body part 163 may move in the up and down direction (the Z-axis direction) along the side. To this end, although not shown in FIGS. 2 and 3, at least one driving motor for moving the first camera 165A, the second camera 165B, and the pollutant remover 167 in the up and down direction (the Z-axis direction) may be provided in the body part 163.

Therefore, the first camera 165A, the second camera 165B, and the pollutant remover 167 may move in the X-axis direction, the Y-axis direction, and the Z-axis direction over the jig unit 130, and simultaneously, may rotate on an X-Y plane.

The first camera 165A may photograph a whole region of the jig unit 130 over the jig unit 130 fixed to the jig fixing part 140 to obtain a whole image of the jig unit 130.

In order to obtain the whole image of the jig unit 130, the first camera 165A may move in a three-axis direction according to a control signal from the control equipment 200 in a whole region of the jig unit 130 to be located in a field of view (FOV) of the first camera 165A, and simultaneously, may perform a focusing operation. The first camera 165A may include a magnification lens for the focusing operation.

The whole image of the jig unit 130 obtained by the first camera 165A may be provided to the control equipment 200, and the control equipment 200 may detect a ferrule candidate region, where a ferrule endface is provided, from the whole image of the jig unit 130, count the number of ferrules which are to be inspected, and calculate an initial inspection target position value of the ferrule candidate region.

The second camera 165B may move to a ferrule region position detected by the control equipment 200 and may photograph a ferrule endface of the ferrule region according to the control signal from the control equipment 200.

The second camera 165B, like the first camera 165A, may move in the three-axis direction according to the control signal from the control equipment 200 in order for the ferrule region to be located in an FOV of the second camera 165B in the whole region of the jig unit 130, and simultaneously, may perform a focusing operation. The second camera 165B, like the first camera 165A, may include a magnification lens for the focusing operation. However, a ferrule endface image captured by the second camera 165B may be used as information for accurately determining a defect of the ferrule endface, and thus, may include a high-resolution magnification lens which is better in performance than the magnification lens included in the first camera 165A.

The second camera 165B may transmit the high-resolution ferrule endface image to the control equipment 200, and the control equipment 200 may analyze the ferrule endface image to determine whether there is the defect of the ferrule endface.

The pollutant remover 167 may move to the ferrule region position detected by the control equipment 200 and may remove pollutants from the ferrule endface of the ferrule region according to the control signal from the control equipment 200. Although not shown in the drawing, a vibration brush including an ultra-micro brush for removing the pollutants of the ferrule endface may be provided in an end of the pollutant remover 167. The vibration brush may vibrate with the ultra-micro brush contacting the ferrule endface, thereby removing the pollutants from the ferrule endface.

The lighting unit 169 may be disposed on a bottom of the body part 163 and may illuminate modules or parts, arranged in the jig unit 130, over the jig unit 130. The first camera 165A may photograph a whole region of the jig unit 130 along with a module or a part including a ferrule endface region projected by the illumination.

Moreover, although not shown, the lighting unit 169 may further include a coaxial lighting unit provided on a side of the second camera 165B. The coaxial lighting unit may illuminate a region of a ferrule endface which is embedded in a certain depth of the optical communication module, and may photograph the ferrule endface projected by the illumination.

Jig Unit 130

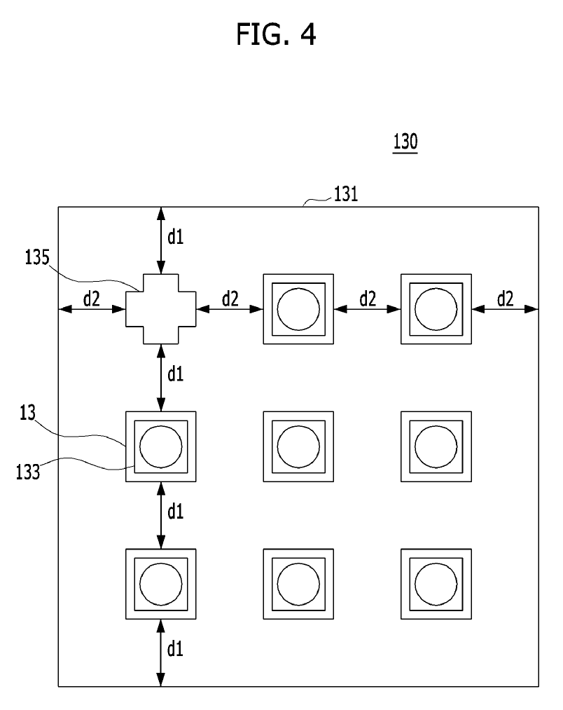

Referring to FIG. 4, the jig unit 130 may include a jig 131 including a plurality of insertion grooves 13 and a plurality of optical communication modules 133 arranged on the jig 131 in an array form.

The jig 131 may include the plurality of insertion grooves 13 which are arranged in an array form in order for the plurality of optical communication modules 133 to be inserted and fixed thereinto. In FIG. 4, each of the insertion grooves 13 is illustrated in a tetragonal shape, but each of the optical communication modules 133 may have various shapes and sizes.

A female type ferrule may be embedded into each of the optical communication modules 133 arranged on the jig 131, and when seen from above, an endface of a ferrule is circular in shape.

An identification marker 135 for selecting an inspection start position may be provided at a specific position on the jig 131.

An insertion groove 13 closest to the identification marker 135 may be set as a groove into which an optical communication module 133 corresponding to a first inspection target is inserted.

A vertical interval between the identification marker 135 and the insertion groove 13 closest to the identification marker 135 and a vertical interval between adjacent insertion grooves 13 may each be set to d1, and a horizontal interval between adjacent insertion grooves may be set to d2. Also, d1 and d2 may each be used as a correction value for correcting an inspection position of a module, where the second camera 165B is inserted into each insertion groove 13, and a position of the pollutant remover 167.

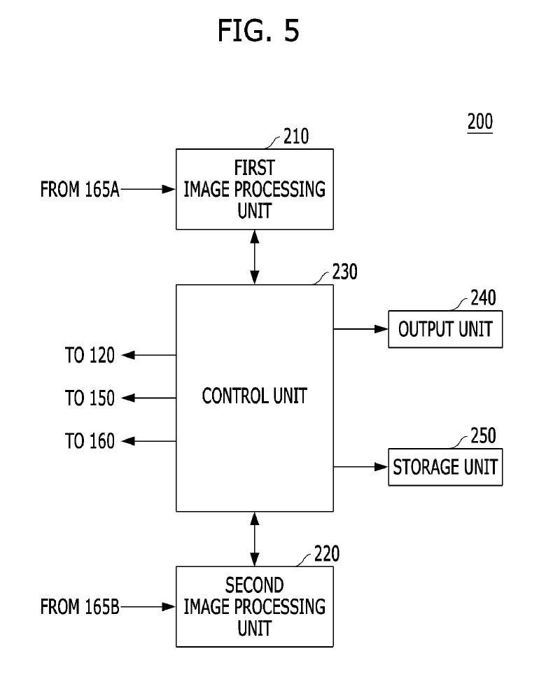

Hereinafter, the control equipment illustrated in FIG. 1 will be described in detail with reference to FIGS. 5 to 7.

FIG. 5 is a block diagram of the control equipment 200 illustrated in FIG. 1.

Referring to FIG. 5, the control equipment 200 may include a first image processing unit 210, a second image processing unit 220, a control unit 230, an output unit 240, and a storage unit 250.

The first image processing unit 210 may recognize a position of a marker region and a position of a candidate region, which is capable of including a ferrule endface corresponding to an inspection target, in a whole image of the jig 131 (illustrated in FIG. 4) input from the first camera 165A, may count the number of candidate regions capable of including a ferrule endface, based on the recognized position of the marker region and the recognized position of the candidate region, and may transmit the counted number of the candidate regions to the control unit 230.

The control unit 230 may calculate a center coordinate value so that the position of the candidate region and the position of the marker region transmitted from the first image processing unit 210 are located in a center of a photographing region of the second camera 165B and a center of a removal region of the pollutant remover 167, may allocate an identification index to the candidate region in a progressive scan order with respect to the marker region, and may generate a position map value including the identification index and the center coordinate value.

Moreover, the first image processing unit 210 may calculate a difference value between the position map value fed back from the control unit 230 and each of the vertical interval “d1” and the horizontal interval “d2” (see FIG. 4) calculated based on the physical properties and lens magnification of the first camera 165A, correct a position of each of the candidate region and the marker region by using the calculated difference value, and transmit a result of the correction to the control unit 230. Therefore, the control unit 230 may reflect the correction result in the position map value to correct the position map value.

That is, a marker region and a candidate region of an inspection target position map generated through the first image processing unit 210 may be converted into an actual position value on the jig 131, and a generated position map value may be transmitted.

The control unit 230 may perform inspection, based on the number of the candidate regions and the position map value obtained from the first image processing unit 210.

The control unit 230 may select, as a first inspection target, a candidate region closest to the marker region from among a plurality of candidate regions with respect to the identification index.

The control unit 230 may control the XY movement stage 150 and the mount head 160 according to the position map value to move the first camera 165A to a first inspection target candidate region on the jig 131.

When the first camera 165A moves to a position of a first candidate region, the control unit 230 may rotate the body part 163 of the mount head 160 by 90 degrees, and simultaneously, may precisely control the XY movement stage 150 to move the pollutant remover 167 to a position of a ferrule region corresponding to the first inspection target.

The pollutant remover 167 moved to the position of the ferrule region may perform an operation of removing pollutants of the ferrule region corresponding to the first inspection target for a predetermined time, and then, when the pollutant removing operation is completed, the control unit 230 may again rotate the mount head 160 by 90 degrees, and simultaneously, may precisely control the XY movement stage 150 to move the second camera 165B to a position on the first candidate region.

The second camera 165B moved to the position on the first candidate region may capture the ferrule endface image and may output the captured ferrule endface image to the second image processing unit 220.

The second image processing unit 220 may perform circle detection on the ferrule endface image input from the second camera 165B to classify a buffer region, a cladding region, and a core region of a ferrule. Also, the second image processing unit 220 may divide the cladding region including the core region into a plurality of regions having similar intensity values by using image processing based on a watershed algorithm and may allocate index to each of the plurality of regions.

The control unit 230 may calculate a difference value between a reference average intensity value and an average intensity value of each of the regions obtained through the division based on the watershed algorithm and may determine the presence of a defect, based on the calculated difference value. Here, the reference average intensity value denotes an intensity value of each of pixels constituting a cladding region of a normal ferrule endface having no pollutant.

In an operation of determining the presence of the defect, the core region may be defined as a center region of the ferrule endface, the buffer region may be defined as a boundary region of the ferrule endface, and the cladding region may be defined as a region between the core region and the buffer region. Since a defect in the buffer region does not affect optical transmission characteristic, whether there is a defect of the ferrule endface cannot be determined by determining whether there is a defect in the core region and the cladding region.

The control unit 230 may generate a result report according to a determination result obtained by determining whether there is the defect of the ferrule endface, generate a final result report based on a combination of the generated result report and the inspection target map, output the final result report through the output unit 240, and store the final result report in the storage unit 250 simultaneously.

The output unit 250 may be an element that converts the final result report into visual or acoustic data. The output unit 250 may include an image display unit, which outputs the final result report as visual data such as a graph and text data, and an audio output unit that outputs the final result report as acoustic data.

As described above, when inspection of a ferrule endface corresponding to a first inspection target is completed, inspection of a second ferrule endface may be performed. Inspections may be performed in a progressive scan order on a plurality of optical communication modules arranged on the jig, and thus, total inspection may be performed on all the optical communication modules. A result of each inspection may be reflected in the final result report, stored in the storage unit 250, and output through the output unit 240 simultaneously.

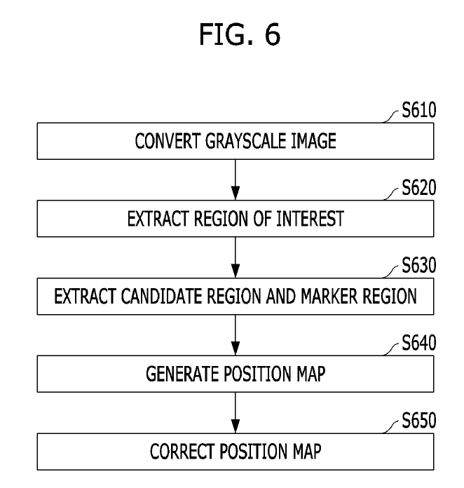

FIG. 6 is a flowchart illustrating an operation performed by the first image processing unit 210 according to an embodiment of the present invention.

Referring to FIG. 6, in step S610, the first image processing unit 210 may convert a whole image of the jig unit 130, input from the first camera 165A, into a grayscale image representing an object feature corresponding to an extraction target.

Subsequently, in step S620, the first image processing unit 210 may convert the grayscale image into a first binary image through a binarization operation based on a halftoning algorithm or an adaptive threshold algorithm, search for a tetragonal mask region corresponding to the jig 131 (illustrated in FIG. 4) in the first binary image, and extract the found mask region as a first region of interest (ROI).

Subsequently, in step S630, the first image processing unit 210 may convert an image including the extracted ROI into a second binary image, extract a plurality of candidate regions capable of including a ferrule endface from the second binary image, and extract a marker region for identifying a candidate region capable of including a ferrule endface corresponding to a first inspection target from among the plurality of candidate regions. The plurality of candidate regions may be extracted through, for example, an edge detection algorithm for detecting an edge and a Hough transform algorithm for detecting a circular object, and the marker region may be extracted based on, for example, a template matching algorithm.

Subsequently, in step S640, the first image processing unit 210 may allocate an index to the plurality of candidate regions in a progressive scan order with respect to the marker region identified as a marker, calculate a center position value of each of the candidate regions, and generate a position map where the plurality of candidate regions and the marker region are displayed, based on the index and the center position value. In this case, the first image processing unit 210 may calculate a size value and a boundary coordinate value of each of the regions in a process of calculating the center position value of each of the candidate regions and the marker region.

Subsequently, in step S650, the first image processing unit 210 may correct the position map by using the calculated center position value, size value, and boundary coordinate value, and the vertical interval “d1” and the horizontal interval “d2” which are actually set in the jig 131. In this manner, the corrected position map may be used to control a rotation movement of the second camera 165B.

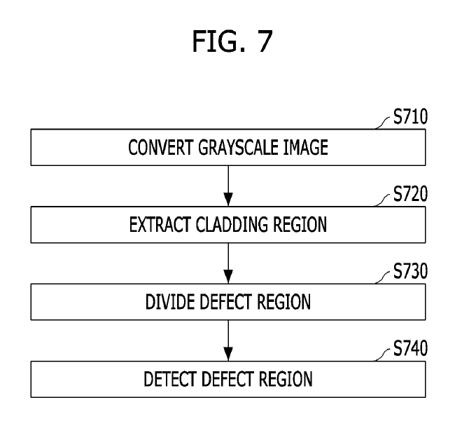

FIG. 7 is a flowchart illustrating an operation performed by the second image processing unit 220 according to an embodiment of the present invention.

Referring to FIG. 7, in step S710, the second image processing unit 220 may convert a ferrule endface image, input from the second camera 165B, into a grayscale image representing an object feature corresponding to an extraction target.

Subsequently, in step S720, the second image processing unit 220 may convert the grayscale image into a first binary image by using the halftoning algorithm or the adaptive threshold algorithm and may extract a cladding region of the ferrule endface by using a largest region shown in the binary image. Also, the second image processing unit 220 may extract boundary pixels corresponding to an edge component of the cladding region in the extracted cladding region to set an inspection limit region for detecting a defect region and may extract the set inspection limit region as an ROI capable of including the defect region.

Subsequently, in step S730, the second image processing unit 220 may divide the extracted ROI into a plurality of defect candidate regions by using the watershed algorithms. Here, the watershed algorithm may perform region extension up to only an edge of the cladding region which has been extracted in step S720, thereby limiting division of an outer region of the cladding region. Also, the watershed algorithm may merge divided regions based on a similarity (for example, a similarity degree of a largest region) between the divided regions to extract a candidate region capable of having a final defect.

Subsequently, in step S740, the second image processing unit 220 may calculate an average value of pixels constituting the respective defect candidate regions which are obtained through the division in step S730, and when there is a region where a standard deviation of the defect candidate regions is large, the second image p-r may determine there to be a defect in a ferrule endface.

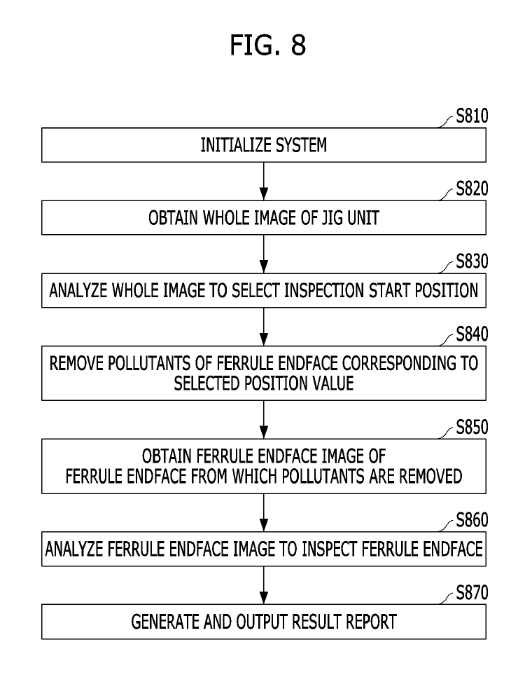

FIG. 8 is a flowchart illustrating a ferrule endface inspecting method according to an embodiment of the present invention. In describing the following operations, details which are similar to or the same as the above-described details will be briefly described.

Referring to FIG. 8, first, in step S810, an operation of initializing a whole system may be performed. In detail, the jig transport robot 120 may unload the jig unit 130 accommodated into the supply unit 110 and may transport the jig unit 130 to the jig fixing part 140.

When the jig unit 130 is transported to the jig fixing part 140, the mount head 60 may rotate and move in order for a whole region of the jig unit 130 to be located in an FOV of the first camera 165A provided in the mount head 160. At this time, the first camera 165A may move in an up and down direction on a side of the mount head 160.

Subsequently, in step S820, the first camera 165A may photograph the whole region of the jig unit 130 to obtain a whole image of the jig unit 130 and may output the whole image of the jig unit 130 to the control equipment 200.

Subsequently, in step S830, the control equipment 200 may analyze the whole image of the jig unit 130 input from the first camera 165A to select an inspection start position.

In detail, the control equipment 200 may convert the whole image into a binary image and may extract a marker region and a plurality of candidate regions from the binary image. Subsequently, the control equipment 200 may correct a position of the marker region and a position of each of the candidate regions by using a difference value between a position value of the marker region in the binary image and a position value of the identification marker on the jig 131. Subsequently, the control equipment 200 may select, as the inspection start position, a position of a ferrule region closest to the marker region among the extracted plurality of candidate regions.

Subsequently, in step S840, the mount head 160 may rotate in a first rotation direction by 90 degrees, and thus, the pollutant remover 167 may move to the inspection start position and may descend toward a ferrule endface located at the inspection start position to remove pollutants of the ferrule endface. Here, a pollutant removing operation may be performed for a certain time.

Subsequently, in step S850, when the pollutant removing operation is completed, the pollutant remover 167 may ascend, and then, the mount head 160 may again rotate by 90 degrees in the same direction as the first rotation direction, whereby the second camera 165B may move to a ferrule endface corresponding to the inspection start position and may photograph the ferrule endface to obtain a ferrule endface image. Subsequently, the obtained ferrule endface image may be output to the control equipment 200.

Subsequently, in step S860, the control equipment 200 may analyze the ferrule endface image to inspect the presence of a defect of the ferrule endface.

In detail, image processing based on the watershed algorithm may be performed on the ferrule endface image, a watershed region capable of having a defect may be divided, and an average intensity value and a standard deviation of each of regions obtained through the division may be calculated, thereby performing inspection on a defect of each region.

Subsequently, in step S870, a result report obtained by determining the presence of the defect may be generated and stored, and simultaneously, the result report may be provided to a user through the image display unit or the audio output unit.

When it is determined in step S860 that there is the defect of the ferrule endface, the pollutant removing operation may be again performed on the pollutant remover 167 after step S860. That is, the head mount 160 may rotate by 90 degrees, and thus, the pollutant remover 167 may again move to a ferrule endface which is checked as having a defect, descend toward the ferrule endface, and remove pollutants of the ferrule endface.

As described above, according to the embodiments of the present invention, since a circular ferrule region is detected, various optical communication modules (or submodules, parts, etc.) with a built-in ferrule may be set as an inspection target irrespective of a type and a size of an optical communication module (or a submodule, a part, or the like) with a built-in ferrule.

Moreover, a ferrule region which is to be inspected may be previously extracted from a whole image obtained by photographing a whole region of a jig, and the presence of a defect may be determined on only the extracted ferrule region. Accordingly, an image processing duration for determining the presence of a defect is shortened, thereby enabling high-speed automation total inspection.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A ferrule endface inspecting device for optical communication modules, the ferrule endface inspecting device comprising:
an XY movement stage;
a mount head moving in a two-axis direction including an X-axis direction and a Y-axis direction by the XY movement stage and rotating on an X-Y plane, first and second cameras being provided on a side of the mount head;
a jig unit disposed under the mount head to fix a plurality of optical communication modules with a built-in ferrule; and
a control unit selecting a ferrule region located at an inspection start position from among a plurality of ferrule regions extracted from a whole image of the jig unit captured by the first camera and analyzing a ferrule endface image obtained through photographing by the second camera, which has rotated and moved to the inspection start position, to determine whether there is a defect of a ferrule endface.

2. The ferrule endface inspecting device of claim 1, wherein the control unit extracts the plurality of ferrule regions from the whole image of the jig unit according to image processing based on an object extraction algorithm.

3. The ferrule endface inspecting device of claim 1, wherein the control unit performs image processing based on a watershed algorithm on the ferrule endface image to determine whether there is the defect of the ferrule endface.

4. The ferrule endface inspecting device of claim 1, wherein the jig unit comprises:
a jig fixing the plurality of optical communication modules in an array form; and
an identification marker provided at a specific position of the jig to select the inspection start position.

5. The ferrule endface inspecting device of claim 4, wherein the control unit extracts a marker region corresponding to the identification marker from the whole image of the jig unit captured by the first camera and selects a ferrule region located at the inspection start position with respect to a position value of the extracted marker region.

6. The ferrule endface inspecting device of claim 5, wherein the control unit corrects a position of the marker region and a position of the ferrule region, based on the identification marker on the jig and an interval between a plurality of insertion grooves into which the plurality of optical communication modules are respectively inserted.

7. The ferrule endface inspecting device of claim 6, wherein the control unit controls a rotation of the mount head to move the second camera to the corrected position of the marker region and the corrected position of the ferrule region.

8. The ferrule endface inspecting device of claim 5, wherein the control unit selects, as the inspection start position, a position of a ferrule region closest to the extracted marker region among the plurality of ferrule regions.

9. The ferrule endface inspecting device of claim 1, wherein the ferrule is built into each of the plurality of optical communication modules in a female type.

10. The ferrule endface inspecting device of claim 1, further comprising: a pollutant remover provided on the side of the mount head, for removing pollutants of the ferrule endface, a micro brush being provided in an end of pollutant remover,
wherein the pollutant remover moves in an up and down direction along the side.

11. A ferrule endface inspecting method for optical communication modules, the ferrule endface inspecting method comprising:
transporting, by a jig transport robot, a jig unit to a jig fixing part, the jig unit fixing a plurality of optical communication modules with a built-in ferrule;
moving, by an XY movement stage, a mount head to on the jig unit, the mount head being movable in an X-axis direction and a Y-axis direction;
obtaining, by a first camera provided in the mount head, a whole image of the jig unit by photographing a whole region of the jig unit;
extracting, by a control unit, a plurality of ferrule regions from the whole image of the jig unit to select a ferrule region located at an inspection start position from among the extracted plurality of ferrule regions;
rotating and moving, by a second camera, to the inspection start position by the mount head to photograph the selected ferrule region; and
analyzing, by the control unit, a ferrule endface image obtained by photographing the selected ferrule region to determine whether there is a defect of a ferrule endface.

12. The ferrule endface inspecting method of claim 11, wherein the selecting of the ferrule region comprises extracting the plurality of ferrule regions from the whole image of the jig unit.

13. The ferrule endface inspecting method of claim 11, wherein the selecting of the ferrule region comprises:
extracting a marker region corresponding to an identification marker provided at a specific position of the jig unit and the plurality of ferrule regions from the whole image of the jig unit; and
selecting a ferrule region closest to the extracted marker region as the ferrule region located at the inspection start position from among the plurality of ferrule regions.

14. The ferrule endface inspecting method of claim 11, further comprising:
between the selecting of the ferrule region and the photographing of the selected ferrule region,
rotating, by the mount head, to move a pollutant remover provided in the mount head to the selected ferrule region;
descending, by the pollutant remover, along a side of the mount head; and
removing pollutants from a ferrule endface in the selected ferrule region by using a micro brush provided in an end of the descended pollutant remover.

15. The ferrule endface inspecting method of claim 11, wherein the photographing of the selected ferrule region comprises:
moving, by the second camera, to the inspection start position according to a rotation of the mount head; and
photographing, by the second camera moved to the inspection start position, the selected ferrule region.
